(19) United States
(12) Patent Application Publication
(10) Pub. No.: US 2014/0133051 A1
(43) Pub. Date: May 15, 2014

(54) CLAMP RING, SPINDLE MOTOR INCLUDING CLAMP RING AND HARD DISK DRIVE INCLUDING SPINDLE MOTOR

(71) Applicant: SAMSUNG ELECTRO-MECHANICS CO., LTD., Suwon (KR)

(72) Inventor: Hyun Ho SHIN, Suwon (KR)

(73) Assignee: SAMSUNG ELECTRO-MECHANICS CO., LTD., Suwon (KR)

(21) Appl. No.: 13/761,936

(22) Filed: Feb. 7, 2013

(30) Foreign Application Priority Data
Nov. 13, 2012 (KR) 10-2012-0128002

(51) Int. Cl. G11B 19/20

(52) U.S. Cl. CPC G11B 19/2009
USPC 360/99.08; 360/99.12

(57) ABSTRACT

There are provided a clamp ring, a spindle motor including the clamp ring and a hard disk drive including the spindle motor. The spindle motor includes: a fixed member; a rotating member rotatably supported by the fixed member using fluid dynamic pressure; and a clamp ring inserted into an outer surface of the rotating member in a radial direction to fix a recording disk.

### CROSS-REFERENCE TO RELATED APPLICATIONS

This application claims the priority of Korean Patent Application No. 10-2012-0128002 filed on Nov. 13, 2012, in the Korean Intellectual Property Office, the disclosure of which is incorporated herein by reference.

### BACKGROUND OF THE INVENTION

1. Field of the Invention

The present invention relates to a clamp ring, a spindle motor including the clamp ring, and a hard disk drive including the spindle motor.

2. Description of the Related Art

In general, a hard disk drive (HDD), an information storage device, reads data stored on a disk or writes data to a disk using a read/write head.

The hard disk drive requires a recording disk driving device capable of driving a recording disk. In the recording disk driving device, a small-sized spindle motor is used.

A rotor hub is mounted on an upper portion of a shaft of the spindle motor. The rotor hub is provided for a recording disk to be mounted thereon and rotating together with the shaft. The rotor hub is fixedly coupled to the upper portion of the shaft and has a disk shape in which it is extended in a radial direction based on the shaft. Therefore, the recording disk mounted on the rotor hub may be fixed by a clamp provided on an upper surface of the rotor hub in an axial direction.

According to the related art, a thickness standard of a hard disk drive (HDD) is 9.5 mm in a hard disk drive for a mobile device and 15 mm in a hard disk drive for a server. Therefore, the spindle motor mounted in the hard disk drive may be somewhat elongated in the axial direction. That is, a bearing span between upper and lower radial bearings may be sufficiently secured.

However, in accordance with the recent trend for the miniaturization of electronic devices, it has been demanded that hard disk drives used in electronic devices have a reduced thickness standard of 5 mm or less. Therefore, the spindle motor used therein has been formed to have a significantly shortened length in the axial direction.

As spindle motors have tended to be thinned, a method of allowing the clamp provided on the upper surface of the rotor hub in the axial direction not to waste space in the axial direction has been demanded.

A clamp member 50, provided on an upper portion of a hub, has been disclosed in the following related art document.

### RELATED ART DOCUMENT

(Patent Document 1) Korean Patent Laid-Open Publication No. 2007-0029457

### SUMMARY OF THE INVENTION

An aspect of the present invention provides a spindle motor capable of allowing a clamp fixing a recording disk not to occupy a space in an axial direction.

According to an aspect of the present invention, there is provided a spindle motor including: a fixed member; a rotating member rotatably supported by the fixed member using fluid dynamic pressure; and a clamp ring inserted into an outer surface of the rotating member in a radial direction to fix a recording disk.

The rotating member may include a hub body extended in an outer radial direction, a cylindrical wall part extended downwardly from an outer end of the hub body in an axial direction, and a disk mounting part extended from a lower end of the cylindrical wall part in the outer radial direction.

The recording disk may be positioned on the disk mounting part, and an outer surface of the cylindrical wall part may be provided with a fixing groove in the radial direction.

A lower edge of the clamp ring in the axial direction may be provided with a fixing protrusion protruding in the inner radial direction, and the fixing protrusion may be inserted into the fixing groove.

A lower edge of the clamp ring in the axial direction may be provided with a bent fixing part bent in the inner radial direction, and the bent fixing part may be inserted into the fixing groove.

A lower edge of the clamp ring in the axial direction may be inserted into the fixing groove so as to be positioned below an upper surface of the disk mounting part in the axial direction.

The fixing protrusion may be continuously provided, or include a plurality of fixing protrusions spaced apart from each other and repeatedly provided in a circumferential direction.

The bent fixing part may be continuously provided, or include a plurality of bent fixing parts spaced apart from each other and repeatedly provided in a circumferential direction.

An upper edge of the clamp ring in the axial direction may be provided with a fixing flange protruding in the outer radial direction so as to press the recording disk positioned on the disk mounting part downwardly in the axial direction and fix the recording disk.

The fixing flange may be continuously provided, or include a plurality of fixing flanges spaced apart from each other and repeatedly provided in a circumferential direction.

The clamp ring may include: a ring body inserted in an axial direction while enclosing an outer surface of the rotating member in the radial direction; a protrusion part extended in an inner radial direction from a lower edge of the ring body in the axial direction to be inserted into a fixing groove in the outer surface of the rotating member in the radial direction; and a fixing flange extended in an outer radial direction from an upper edge of the ring body in the axial direction to press the recording disk downwardly in the axial direction and fix the recording disk.

According to another aspect of the present invention, there is provided a clamp ring including: a ring body; a protrusion part extended in an inner radial direction from a lower edge of the ring body in an axial direction; and a fixing flange extended in an outer radial direction from an upper edge of the ring body in the axial direction.

According to another aspect of the present invention, there is provided a hard disk drive including: the spindle motor as described above; a magnetic head writing data to a recording disk and reading data from the recording disk; and a head transfer part transferring the magnetic head to a predetermined position above the recording disk, wherein a thickness standard of the hard disk drive is 5 mm or less.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a schematic cross-sectional view showing a spindle motor according to an embodiment of the present invention;

FIGS. 2 through 5 are cut-away perspective views of a clamp ring according to embodiments of the present invention;

FIG. 6 is a schematic cross-sectional view showing a spindle motor according to another embodiment of the present invention; and

FIGS. 7A and 7B are schematic cross-sectional views of a disk driving device using a spindle motor according to an embodiment of the present invention.

### DETAILED DESCRIPTION OF THE EMBODIMENTS

Hereinafter, embodiments of the present invention will be described in detail with reference to the accompanying drawings.

The invention may, however, be embodied in many different forms and should not be construed as being limited to the embodiments set forth herein. Rather, these embodiments are provided so that this disclosure will be thorough and complete, and will fully convey the scope of the invention to those skilled in the art.

In the drawings, the shapes and dimensions of components maybe exaggerated for clarity, and the same reference numerals will be used throughout to designate the same or like components.

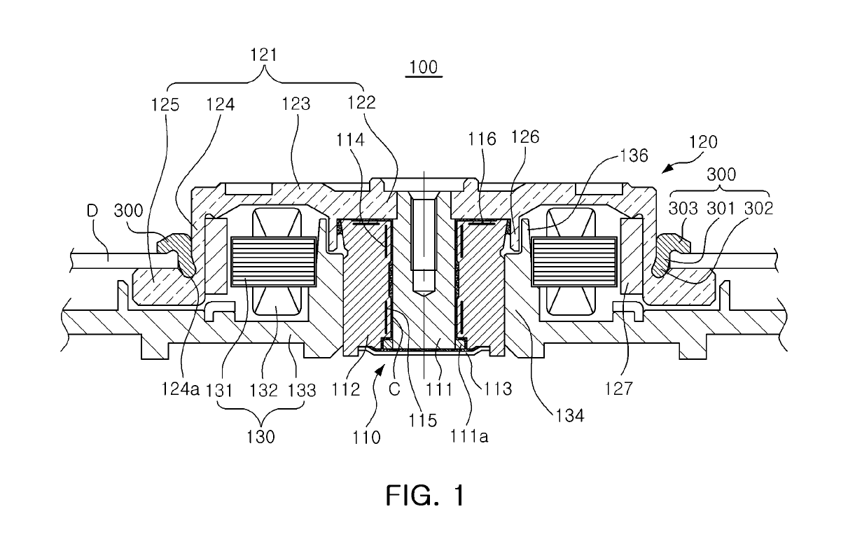

FIG. 1 is a schematic cross-sectional view showing a spindle motor according to an embodiment of the present invention.

Referring to FIG. 1, a spindle motor 100 according to the embodiment of the present invention may include a fluid dynamic bearing assembly 110 including a shaft 111, a rotor 120, and a sleeve 112; the rotor 120 including a hub 121; and a stator 130 including a base member 133 and a core 131 having a coil 132 wound therearound.

Terms with respect to directions will first be defined. As viewed in FIG. 1, an axial direction refers to a vertical direction based on the shaft 111, and an outer radial or inner radial direction refers to a direction toward an outer edge of the hub 121 based on the shaft 111 or a direction toward the center of the shaft 111 based on the outer edge of the hub 121. In addition, a circumferential direction refers to a direction of rotation based on rotation of the shaft in a position spaced apart from the rotational shaft by a predetermined distance in a radial direction.

Further, in the following description, a rotating member may refer to a rotating member such as the shaft 111, the rotor 120 including the hub 121, and a magnet 127 mounted on the rotor 120, and the like, while a fixed member, a member other than the rotating member, may be a member fixed relative to the rotating member, such as the sleeve 112, the stator 130, the base member 133, and the like.

The fluid dynamic bearing assembly 110 may include the shaft 111, the sleeve 112, a stopper 111a, and the hub 121, wherein the hub 121 may be a component configuring the fluid dynamic bearing assembly 110 while simultaneously configuring the rotor 120 to be described below.

The sleeve 112 may rotatably support the shaft 111.

Here, the shaft 111 may be inserted into a shaft hole of the sleeve 112 so as to have a micro clearance therebetween, thereby forming a bearing clearance C. In addition, the bearing clearance may be filled with oil.

In addition, upper and lower radial dynamic pressure grooves 114 and 115 may be vertically formed in at least one of an outer diameter of the shaft 111 and an inner diameter of the sleeve 112. The upper and lower radial dynamic pressure grooves 114 and 115 may generate fluid dynamic pressure in the radial direction at the time of rotation of the shaft 111 to form a radial dynamic pressure bearing, such that rotation of the rotor 120 may be smoothly supported.

The upper and lower radial dynamic pressure grooves 114 and 115 may be formed in plural in the circumferential direction and have at least one of a herringbone shape, a spiral shape, and a helical shape. However, the upper and lower radial dynamic pressure grooves 114 and 115 may have any shape as long as radial dynamic pressure may be generated.

The sleeve 112 may be provided with a circulation hole allowing the upper and lower portions thereof to be in communication with each other. The circulation hole may allow a balance in pressure generated in the upper and lower radial dynamic pressure grooves 114 and 115 to be maintained and discharge air bubbles, or the like, present in the fluid dynamic bearing assembly 110 by circulation.

Here, a lower end portion of the shaft 111 may be provided with the stopper 111a protruding in the outer radial direction. The stopper 111a may be caught by a lower end surface of the sleeve 112 to limit floating of the shaft 111 and the rotor 120.

Further, the sleeve 112 in the axial direction may include a cover member 113 coupled to a lower portion thereof so as to cover the shaft hole to prevent the leakage of oil (lubricating fluid).

The hub 121 is a rotating member coupled to the shaft 111 and rotating together therewith. The hub 121 may configure the rotor 120 while simultaneously configuring the fluid dynamic bearing assembly 110, and accordingly, it will be described in detail together with the rotor 120.

The rotor 120 may be a rotating structure rotatably provided with respect to the stator 130. The rotor 120 may include the hub 121 having an annular ring-shaped magnet 127 disposed on an inner peripheral surface thereof, the magnet 127 corresponding to the core 131 to be described below, having a predetermined interval therebetween.

In other words, the hub 121 may be a rotating member coupled to an upper end portion of the shaft 111 to rotate together with the shaft 111.

Here, the magnet 127 may be a permanent magnet generating magnetic force having a predetermined strength by alternately magnetizing an N pole and an S pole thereof in the circumferential direction.

In addition, the hub 121 may include a hub body 123 fixed to the upper end portion of the shaft 111 and extended in the outer radial direction and a cylindrical wall part 124 protruding downwardly from an outer end of the hub body 123. The cylindrical wall part 124 may include the magnet 127 coupled to an inner peripheral surface thereof. Further, the hub 121 may include a disk mounting part 125 protruding from a lower end of the cylindrical wall part 124 in the outer radial direction.

The hub 121 may have a main wall part 126 extended downwardly in the axial direction so as to correspond to an outer portion of the upper portion of the sleeve 112. More specifically, the hub 121 may include the main wall part 126 extended downwardly from the disk part 123 in the axial direction. A liquid-vapor interface sealing the oil may be formed between the outer portion of the sleeve 112 and an inner portion of the main wall part 126.

In addition, an inner surface of the main wall part 126 may be tapered, such that an interval between the inner surface of the main wall part 126 and the outer surface of the sleeve 112 becomes wider downwardly in the axial direction to facilitate the sealing of the oil. Further, the outer surface of the sleeve 112 may be tapered.

Furthermore, an outer portion of the main wall part 126 maybe formed to correspond to an upper portion 136 of amounting part 134 protruding upwardly from the base member 133.

Meanwhile, a thrust dynamic pressure groove 116 may be formed in a portion in which the hub 121 and the sleeve 112 face each other. The thrust dynamic pressure groove 116 may be formed in plural in the circumferential direction and have a spiral shape, a herringbone shape, or a helical shape. However, the thrust dynamic pressure groove 116 may have any shape as long as dynamic pressure may be generated thereby.

In the case in which the shaft 111 rotates relatively with respect to the sleeve 112, the thrust dynamic pressure groove 116 may generate thrust fluid dynamic pressure to form a thrust dynamic pressure bearing between the hub 121 and the sleeve 112.

The stator 130 may include the core 131, the coil 132, and the base member 133.

In other words, the stator 130 may be a fixed member including the coil 132 generating electromagnetic force having a predetermined magnitude at the time of application of power and a plurality of cores 131 having the coil 132 wound therearound.

The core 131 may be fixedly disposed on an upper portion of the base member 133 including a printed circuit board (not shown) having a pattern circuit printed thereon, and a coil hole having a predetermined size may be formed to penetrate through the base member 133 so as to expose the coil 132 downwardly. In addition, the coil 132 may be electrically connected to the printed circuit board (not shown) so that external power may be supplied thereto.

Further, the fluid dynamic bearing assembly 110 may be mounted on the base member 133. The base member 133 may be manufactured using aluminum (Al) in a die casting scheme or manufactured by performing plastic working (for example, press working) on a steel sheet.

The base member 133 may include the mounting part 134 protruding upwardly in the axial direction. The core 131 may be mounted on an outer surface of the mounting part 134, and the sleeve 112 may be insertedly fixed to an inner surface thereof. In addition, the upper portion 136 of the inner surface of the mounting part 134 may be formed to face the outer surface of the main wall part 126. An interval between the main wall part 126 and the upper portion 136 of the mounting part 134 facing each other may be significantly narrow so as to form a labyrinth seal.

Meanwhile, in accordance with the recent trend for thinness in hard disk drives (HDDs), a spindle motor mounted therein is manufactured to be thin (a HDD standard of 5 mm or less). Therefore, in the thin spindle motor, a length of a shaft maybe shortened, such that it maybe difficult to secure a span between upper and lower radial bearings.

According to the related art, a clamp was provided on an upper surface of a rotor hub in an axial direction, such that the clamp occupied a space in the axial direction. However, in accordance with the recent trend for thinness in spindle motors, in order to secure a span length of the radial bearing, a method of allowing the clamp positioned on the upper surface of the rotor hub not to occupy space in the axial direction has been required.

Therefore, in the embodiment of the present invention, a clamp ring 300 may be provided to be inserted into the outer surface of the rotating member, that is, the hub 121, in the radial direction, to fix a recording disk D.

That is, in the embodiment of the present invention, the recording disk D may be positioned on an upper surface of the disk mounting part 125. Therefore, the clamp ring 300 may be fixed to the outer surface of the hub 121 in the radial direction, more particularly, to an outer surface of the cylindrical wall part 124 in the radial direction while simultaneously pressing the recording disk D downwardly in the axial direction. Here, a lower edge of the clamp ring 300 may protrude in the inner radial direction so as to be inserted into a fixing groove 124a provided in the cylindrical wall part 124, and an upper edge thereof may protrude in the outer radial direction so as to press the recording disk D downwardly in the axial direction.

That is, the clamp ring 300 may include a ring body 301 inserted in the axial direction while enclosing the outer surface of the rotating member (more particularly, the cylindrical wall part 124) in the radial direction, a protrusion part 302 extended in the inner radial direction from a lower edge of the ring body 301 in the axial direction to thereby be inserted into the fixing groove 124a of the outer surface of rotating member (more particularly, the cylindrical wall part 124) in the radial direction, and a fixing flange 303 extended in the outer radial direction from an upper edge of the ring body 301 in the axial direction to press the recording disk D downwardly in the axial direction and fix the same.

Meanwhile, although FIG. 1 shows that only one recording disk D is provided, this is only an example, and two or more recording disks D may be stacked. In this case, a spacer may be interposed between the recording disks D to allow the recording disks D to be spaced apart from each other.

In the case in which a plurality of recording disks D are provided, the clamp ring 300 may be further elongated in the axial direction.

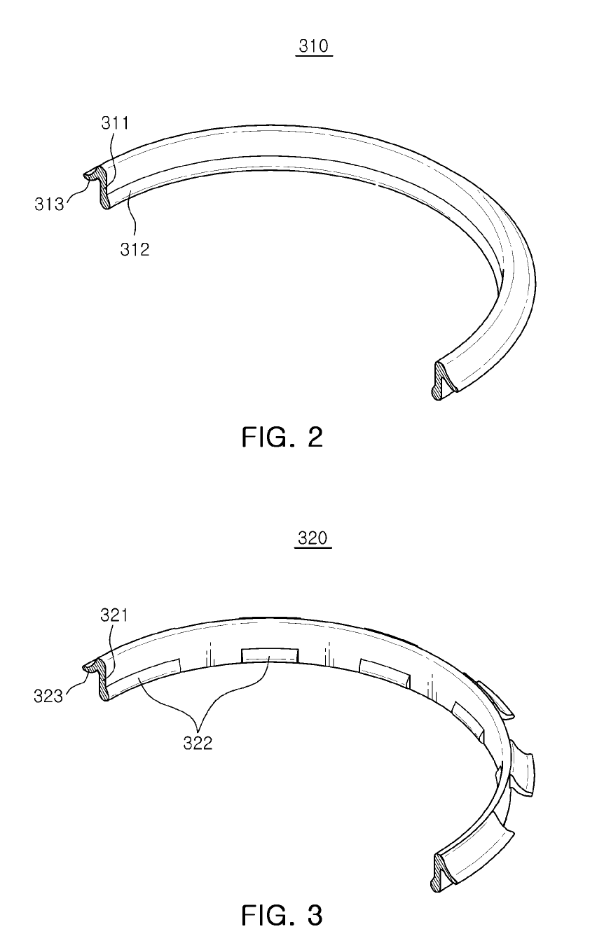

Embodiments of the clamp ring 300 will be described below in detail with reference to FIGS. 2 through 5.

FIGS. 2 through 5 are cut-away perspective views showing a clamp ring according to embodiments of the present invention.

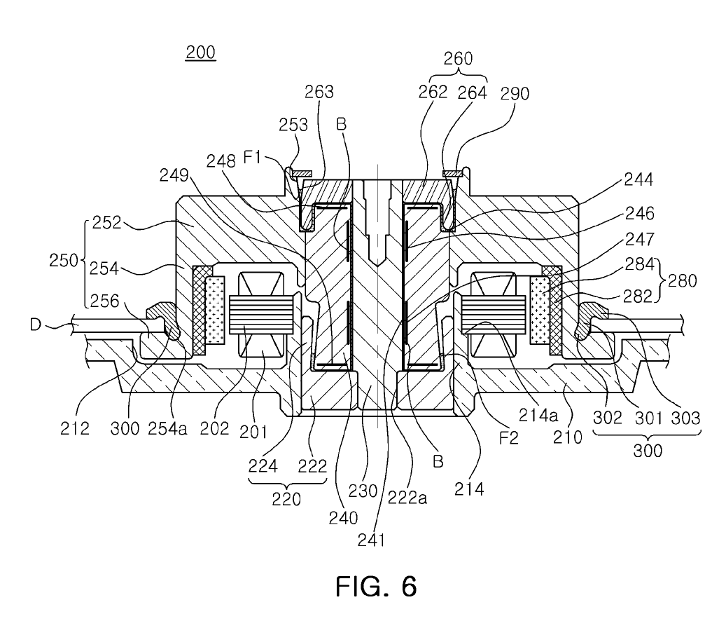

The clamp ring 300 (310, 320, 330, or 340) according to the embodiments of the present invention may include the ring body 301, the protrusion part 302 extended in the inner radial direction from the lower edge of the ring body 301 in the axial direction, and the fixing flange 303 extended in the outer radial direction from the upper edge of the ring body 301 in the axial direction. A description of a coupling structure in which the clamp ring 300 (310, 320, 330, or 340) is fixed to the spindle motor 100 or 200 is provided with reference to FIG. 1 or 6. Hereinafter, the shape of the clamp ring will be described in detail.

Referring to FIG. 2, the clamp ring 310 according to the embodiment of the present invention may include a ring body 311 provided in a continuous ring shape in the circumferential direction, a fixing protrusion 312 protruding in the inner radial direction from a lower edge of the ring body 311 and continuously provided in the circumferential direction, and a fixing flange 313 extended in the outer radial direction from an upper edge of the ring body 311 in the axial direction and continuously provided in the circumferential direction.

Hereinafter, in the case in which the protrusion part 302 is formed to protrude from the lower edge of the ring body 301, the protrusion part 302 will be called the “fixing protrusion,” and in the case in which the lower edge of the ring body 301 is bent to form the protrusion part 302, the protrusion part 302 will be called the “bent fixing part”

Meanwhile, although the fixing flange 313 continuously provided in the circumferential direction is illustrated in the present embodiment, the fixing flange may have a plurality of fixing flanges 323 discontinuously provided, that is, spaced apart from each other at a predetermined interval and repeatedly provided in the circumferential direction as shown in FIG. 3.

Referring to FIG. 3, the clamp ring 320 according to the embodiment of the present invention may include a ring body 321 provided in a continuous ring shape in the circumferential direction, fixing protrusions 322 protruding in the inner radial direction from a lower edge of the ring body 321 and discontinuously formed, that is, spaced apart from each other at a predetermined interval and repeatedly provided in the circumferential direction, and fixing flanges 323 extended in the outer radial direction from an upper edge of the ring body 321 in the axial direction, that is, spaced apart from each other at a predetermined interval and repeatedly provided in the circumferential direction.

Here, the same number of fixing protrusions 322 and fixing flanges 323 may be discontinuously provided at the same positions as each other in the circumferential direction as shown in FIG. 3.

Meanwhile, although the fixing flanges 323 are shown as being discontinuously provided in the circumferential direction in the present embodiment, the fixing flange 313 may be continuously provided in the circumferential direction as described in FIG. 2.

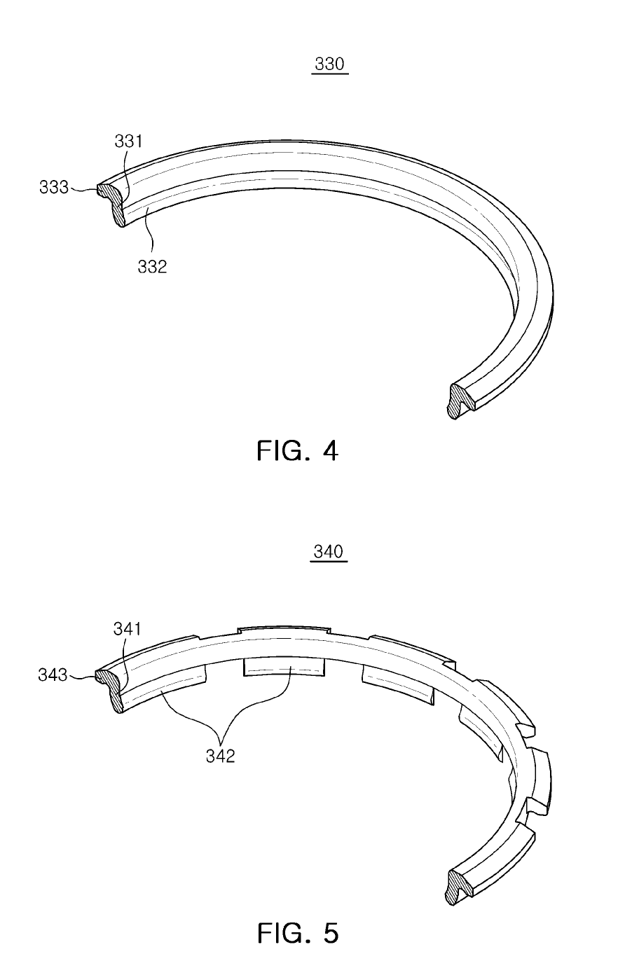

Next, referring to FIG. 4, the clamp ring 330 according to the embodiment of the present invention may include a ring body 331 provided in a continuous ring shape in the circumferential direction, a bent fixing part 332 formed by allowing a lower edge of the ring body 331 to be bent in the inner radial direction and continuously provided in the circumferential direction, and a fixing flange 333 extended in the outer radial direction from an upper edge of the ring body 331 in the axial direction and continuously provided in the circumferential direction.

Meanwhile, although the fixing flange 333 is shown as being continuously provided in the circumferential direction in the present embodiment, the fixing flange 333 may have the form of fixing flanges 343 discontinuously provided, that is, spaced apart from each other at a predetermined interval and repeatedly provided in the circumferential direction as shown in FIG. 5.

Next, referring to FIG. 5, the clamp ring 340 according to the embodiment of the present invention may include a ring body 341 provided in a continuous ring shape in the circumferential direction, bent fixing parts 342 formed by allowing a lower edge of the ring body 341 to be bent in the inner radial direction and discontinuously provided, that is, spaced apart from each other at a predetermined interval and repeatedly provided in the circumferential direction, and the fixing flanges 343 extended in the outer radial direction from an upper edge of the ring body 341 in the axial direction and discontinuously formed, that is, spaced apart from each other at a predetermined interval and repeatedly provided in the circumferential direction.

Here, the same number of bent fixing parts 342 and fixing flanges 343 may be discontinuously provided at the same positions as each other in the circumferential direction as shown in FIG. 5.

Meanwhile, although the fixing flanges 343 are shown as being discontinuously provided in the circumferential direction in the present embodiment, the fixing flanges may have the form of the fixing flange 333 continuously provided in the circumferential direction as described in FIG. 4.

Although a shaft-rotating type structure in which the hub is coupled to the shaft to rotate has been described in the embodiment of FIG. 1, the present invention may also applied to a fixed shaft type structure in which the hub is coupled to the sleeve to rotate. That is, the clamp ring 300 (310, 320, 330, or 340) according to the embodiment of the present invention may be used in a fixed shaft type structure to be described with reference to FIG. 6, as well as the shaft-rotating type structure described with reference to FIG. 1.

FIG. 6 is a schematic cross-sectional view showing a spindle motor according to another embodiment of the present invention.

Referring to FIG. 6, a spindle motor 200 according to another embodiment of the present invention may include a base member 210, a lower thrust member 220, a shaft 230, a sleeve 240, a hub 250, an upper thrust member 260, and a cap member 290.

Here, terms with respect to directions will be defined. As viewed in FIG. 6, an axial direction refers to a vertical direction, that is, a direction from a lower portion of the shaft 230 toward an upper portion thereof or a direction from the upper portion of the shaft 230 toward the lower portion thereof, a radial direction refers to a horizontal direction, that is, a direction from the shaft 230 toward an outer peripheral surface of the hub 250 or from the outer peripheral surface of the hub 250 toward the shaft 230, and a circumferential direction refers to a direction of rotation at a predetermined radius at the rotation center. For example, the circumferential direction refers to a direction of rotation along the outer peripheral surface of the hub 150.

The spindle motor 200 according to the embodiment of the present invention may use a fluid dynamic bearing assembly, thereby allowing a rotating member to be smoothly rotate relatively with respect to a fixed member.

Here, the fluid dynamic bearing assembly may be configured of members rotating relatively by fluid pressure generated in a lubricating fluid and may include the lower thrust member 220, the sleeve 240, the shaft 230, the upper thrust member 260, and the hub 250.

In addition, the rotating member, a member rotating relatively with respect to the fixed member, may include the sleeve 240, the hub 250, and a magnet 284 provided in the hub 250.

Further, the fixed member, a member fixed relative to the rotating member, may include the base member 210, the shaft 230, the lower thrust member 240, and the upper thrust member 260.

The base member 210 may include a mounting groove 212 to form a predetermined space with the hub 250. In addition, the base member 210 may include a coupling part 214 extended upwardly in the axial direction and having a stator core 202 installed on an outer peripheral surface thereof.

In addition, the coupling part 214 may include a seating surface 214a provided on the outer peripheral surface thereof so that the stator core 202 maybe seated and installed thereon. Further, the stator core 202 seated on the coupling part 214 may be disposed above the mounting groove 212 of the base member 210.

Meanwhile, the base member 210 according to the embodiment of the present invention may be manufactured by performing plastic working on a rolled steel sheet. More specifically, the base member 210 may be manufactured by a pressing method, a stamping method, a deep drawing method, or the like. However, the base member 210 is not limited to being manufactured by the above-mentioned method, but may be manufactured by various methods that are not described in the present specification such as an aluminum die-casting method, or the like.

Meanwhile, since the base member 210 is manufactured by performing plastic working on the rolling steel sheet, the base member 210 may be thin and have a uniform thickness. Therefore, it may not be easy to integrally form the coupling part 214 included in the base member 210. Accordingly, in the case of the base member 210 according to the embodiment of the present invention, the coupling part 214 may be manufactured as a separate member and then coupled to the base member 210 at the time of assembling of the spindle motor.

The lower thrust member 220 may be fixed to the base member 210. That is, the lower thrust member 220 may be insertedly installed in the coupling part 214. More specifically, an outer peripheral surface of the lower thrust member 220 may be bonded to an inner peripheral surface of the coupling part 214.

Meanwhile, the lower thrust member 220 may include a disk part 222 having an inner surface fixed to the shaft 230 and an outer surface fixed to the base member 210 and an extension part 224 extended upwardly from the disk part 222 in the axial direction.

That is, the lower thrust member 220 may have a cup shape with a hollow hole. That is, the lower thrust member 220 may have a ‘ [symbol] ’ shaped cross section.

In addition, the disk part 222 may be provided with an installation hole 222a in which the shaft 230 is installed, and the shaft 230 may be insertedly mounted in the installation hole 222a.

In addition, the lower thrust member 220 may be included, together with the base member 210, in the fixed member, that is, a stator.

Meanwhile, the outer surface of the lower thrust member 220 may be bonded to an inner surface of the base member 210 by an adhesive and/or welding. In other words, the outer surface of the lower thrust member 220 may be fixedly bonded to an inner surface of the coupling part 214 of the base member 210.

In addition, a lower thrust dynamic pressure groove 249 for generating thrust fluid dynamic pressure may be formed in at least one of an upper surface of the lower thrust member 220 and a lower surface 240b of the sleeve 240. Although FIG. 6 shows that the lower thrust dynamic pressure groove 249 is formed in the lower surface of the sleeve 240, the lower thrust dynamic pressure groove is not limited thereto, but may be provided in the lower thrust member 220 facing the lower surface of the sleeve 240.

Further, the lower thrust member 220 may also serve as a sealing member for preventing the lubricating fluid from being leaked.

The shaft 230 may be fixedly installed on at least one of the lower thrust member 220 and the base member 210. That is, a lower end portion of the shaft 230 may be inserted into the installation hole 222a formed in the disk part 222 of the lower thrust member 220.

In addition, the lower end portion of the shaft 230 may be bonded to the inner surface of the disk part 222 by an adhesive and/or welding. Therefore, the shaft 230 may be fixed.

However, although the shaft 230 is fixedly installed on the lower thrust member 220 byway of example in the present embodiment, the present invention is not limited thereto. That is, the shaft 230 may also be fixed to the base member 210.

Meanwhile, the shaft 230 may also be included, together with the lower thrust member 220 and the base member 210, in the fixed member, that is, the stator.

Meanwhile, an upper surface of the shaft 230 may be provided with a coupling unit, for example, a screw part so that a cover member (not shown) may be fixedly installed.

The sleeve 240 may be rotatably installed on the shaft 230. To this end, the sleeve 240 may include a through-hole 241 into which the shaft 230 is inserted. Meanwhile, in the case in which the sleeve 240 is installed on the shaft 230, an inner peripheral surface of the sleeve 240 and an outer peripheral surface of the shaft 230 maybe disposed to be spaced apart from each other by a predetermined interval to form a bearing clearance B therebetween. In addition, the bearing clearance B may be filled with the lubricating fluid.

Meanwhile, the upper end portion of the sleeve 240 may be provided with a step surface 244 in order to form a labyrinth shaped sealing part between the step surface 244 and the upper thrust member 260. The lubricating fluid may be firmly sealed by the labyrinth shaped sealing part formed between the step surface 244 and the upper thrust member 260.

Meanwhile, the upper thrust member 260 may have an inclined part 263 formed on an outer surface of an upper end portion thereof so as to form a first liquid-vapor interface F1 between the upper thrust member 260 and the hub 250, wherein the inclined part 263 has an outer diameter larger in an upper portion thereof than in a lower portion thereof.

In other words, the inclined part 263 having the larger outer diameter in the upper portion thereof than in the lower portion thereof may be formed on the upper end portion of the upper thrust member 260 so that the first liquid-vapor interface F1 may be formed in a space between an outer peripheral surface of the upper thrust member 260 and an inner peripheral surface of the hub 250.

In addition, the hub 250 may be bonded to an outer peripheral surface of the sleeve 240. That is, a lower portion of the step surface 244 may have a shape corresponding to that of an inner surface of the hub 250, such that the hub 250 may be fixedly installed thereon. That is, the sleeve 240 may include a bonding surface formed on the outer peripheral surface thereof.

Here, the sleeve 240 and the hub 250 may be formed integrally with each other. In the case in which the sleeve 240 and the hub 250 are formed integrally with each other, since both of the sleeve 140 and the hub 250 are provided in a single member, the number of components may be reduced, such that it may be easy to assemble the product, and an assembly tolerance may be reduced.

Meanwhile, a lower end portion of the outer peripheral surface of the sleeve 240 may be inclined upwardly in the inner radial direction so as to form a liquid-vapor interface together with the extension part 224 of the lower thrust member 220.

That is, the lower end portion of the sleeve 240 may be inclined upwardly in the inner radial direction so that a second liquid-vapor interface F2 may be formed in a space between the outer peripheral surface of the sleeve 240 and the extension part 224 of the lower thrust member 220. That is, a sealing part of the lubricating fluid may be formed in the space between the outer peripheral surface of the sleeve 240 and the extension part 224 of the lower thrust member 220.

As described above, since the second liquid-vapor interface F2 is formed in the space between the lower end portion of the sleeve 240 and the extension part 224, the lubricating fluid filling the bearing clearance B forms the first and second liquid-vapor interfaces F1 and F2.

In addition, the sleeve 240 may include upper and lower radial dynamic grooves 246 and 247 formed in the inner surface thereof in order to generate fluid dynamic pressure through the lubricating fluid filling the bearing clearance B at the time of rotation of the sleeve 240.

However, the upper and lower radial dynamic pressure grooves 246 and 247 are not limited to being formed in the inner peripheral surface of the sleeve 240 as shown in FIG. 6, but may be formed in the outer peripheral surface of the shaft 230.

The upper and lower radial dynamic pressure grooves 246 and 247 may have various shapes such as a herringbone shape, a spiral shape, a helical shape, or the like.

The hub 250 may be coupled to the sleeve 240 to rotate together with the sleeve 240.

The hub 250 may include a hub body 252 including an insertion part formed therein so that the upper thrust member 260 is insertedly disposed therein, a cylindrical wall part 254 extended from an end of the hub body 252 and having a magnet assembly 280 mounted on an inner surface thereof, and a disk mounting part 256 extended from an end of the cylindrical wall part 254 in the outer radial direction.

Meanwhile, a lower end portion of an inner surface of the hub body 252 may be bonded to the outer surface of the sleeve 240. That is, the lower end portion of the inner surface of the hub body 252 may be bonded to the bonding surface of the sleeve 240 by an adhesive and/or welding.

Therefore, the sleeve 240 may rotate together with the hub 250 at the time of rotation of the hub 250.

In addition, the cylindrical wall part 254 may be extended downwardly from the hub body 252 in the axial direction. Further, the cylindrical wall part 254 may have the magnet assembly 280 fixedly installed on the inner surface thereof.

Meanwhile, the magnet assembly 280 may include a yoke 282 fixedly installed on the inner surface of the cylindrical wall part 254 and the magnet 284 installed on an inner peripheral surface of the yoke 282.

The magnet 284 may have an annular ring shape and may be a permanent magnet generating a magnetic field having a predetermined strength by alternately magnetizing an N pole and an S pole in the circumferential direction.

Meanwhile, the magnet 284 may be disposed to face a front end of the stator core 202 having a coil 201 wound therearound and generate driving force through electromagnetic interaction with the stator core 202 having the coil 201 wound therearound so that the hub 250 may be rotated by the driving force.

Meanwhile, the upper thrust member 260 may be fixedly installed on the upper end portion of the shaft 230 and form the liquid-vapor interface together with the sleeve 240 or the hub 250.

In addition, the upper thrust member 260 may include a body 262 having an inner surface bonded to the shaft 230 and a protrusion part 264 extended from the body 262 to thereby form the liquid-vapor interface together with the inclined part 263.

The protrusion part 264 may be extended downwardly from the body 262 in the axial direction and have an inner surface facing the outer surface of the sleeve 240 and an outer surface facing the inner surface of the hub 250.

In addition, the protrusion part 264 may be extended from the body 262 so as to be provided in parallel with the shaft 230.

In addition, the upper thrust member 260, which is also a fixed member fixedly installed together with the base member 210, the lower thrust member 220, and the shaft 230, is a member configuring the stator.

Meanwhile, since the upper thrust member 260 is fixedly installed on the shaft 230 and the sleeve 240 rotates together with the hub 250, the first liquid vapor interface F1 may be formed in the space between the hub 250 and the protrusion part 264. Therefore, the hub 250 may include an inclined part 253 provided on the inner surface thereof.

However, the protrusion part 264 of the upper thrust member 260 may be disposed in a space formed between the sleeve 240 and the hub 250. In addition, each of the spaces formed between the sleeve 240 and a lower surface of the body 262 of the upper thrust member 260, between the outer surface of the sleeve 240 and the inner surface of the protrusion part 264, and between the outer surface of the protrusion part 264 and the inner surface of the hub 250 may be filled with the lubricating fluid in a labyrinth shape, thereby forming a sealing part.

Therefore, the first liquid vapor interface F1 may be formed in the space formed between the outer surface of the upper thrust member 260 and the inner surface of the hub 250 as shown in FIG. 6 and may be formed between the outer surface of the sleeve 240 and the inner surface of the protrusion part 264. In the case of the latter, the outer surface of the sleeve 240 or the inner surface of the protrusion part 264 may be inclined to thereby facilitate sealing of the lubricating fluid.

Meanwhile, an upper thrust dynamic pressure groove 248 for generating thrust dynamic pressure may be formed in at least one of a lower surface of the upper thrust member 260 and the upper surface of the sleeve 240 disposed to face the lower surface of the upper thrust member 260.

In addition, the upper thrust member 260 may also serve as a sealing member preventing the lubricating fluid filling the bearing clearance B from being leaked upwardly.

Further, the cap member 290 may be provided to cover the space formed between the upper thrust member 260 and the hub 250.

The cap member 290 is provided in a ring shape, and an outer edge of the cap member 290 may be fixed to the inner portion of the hub 250.

Meanwhile, in accordance with the recent trend for thinness in hard disk drives (HDDs), a spindle motor mounted therein is manufactured to have a reduced thickness (a HDD standard of 5 mm or less). Therefore, in the thin spindle motor, a length of a shaft may be shortened, such that it is difficult to secure a span between upper and lower radial bearings.

According to the related art, a clamp is provided on an upper surface of a hub in an axial direction, such that the clamp occupies a space in the axial direction. However, in accordance with the recent trend toward thinness in spindle motors, in order to secure a span length of the radial bearing, a method of allowing the clamp positioned on the upper surface of the hub not to occupy space in the axial direction has been required.

Therefore, in the embodiment of the present invention, a clamp ring 300 may be provided be inserted into the outer surface of the rotating member, that is, the hub 250 in the radial direction, to fix a recording disk D.

That is, in the embodiment of the present invention, the recording disk D may be positioned on an upper surface of the disk mounting part 256. Therefore, the clamp ring 300 may be fixed to the outer surface of the hub 250 in the radial direction, more particularly, to an outer surface of the cylindrical wall part 254 in the radial direction while simultaneously pressing the recording disk D downwardly in the axial direction. Here, a lower edge of the clamp ring 300 may protrude in the inner radial direction so as to be inserted into a fixing groove 254a provided in the cylindrical wall part 254, and an upper edge thereof may protrude in the outer radial direction so as to press the recording disk D downwardly in the axial direction.

That is, the clamp ring 300 may include a ring body 301 inserted in the axial direction while enclosing the outer surface of the rotating member (more particularly, the cylindrical wall part 254) in the radial direction, a protrusion part 302 extended in the inner radial direction from a lower edge of the ring body 301 in the axial direction to thereby be inserted into the fixing groove 254a of the outer surface of rotating member (more particularly, the cylindrical wall part 254) in the radial direction, and a fixing flange 303 extended in the outer radial direction from an upper edge of the ring body 301 in the axial direction to press the recording disk D downwardly in the axial direction and fix the same.

Descriptions of embodiments of the clamp ring 300 have been provided with reference to FIGS. 2 through 5.

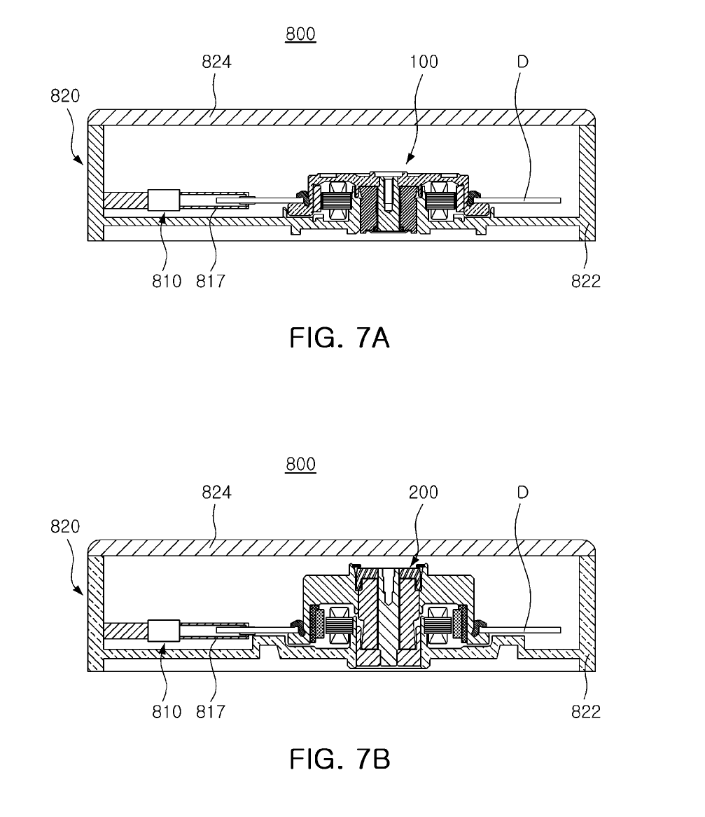

FIGS. 7A and 7B are schematic cross-sectional views of a disk driving device using a spindle motor according to an embodiment of the present invention.

Referring to FIGS. 7A and 7B, a disk driving device 800 including the spindle motor 100 or 200 mounted therein according to the embodiment of the present invention may be a hard disk drive and include the spindle motor 100 or 200, ahead transfer part 810, and a housing 820. A thickness standard of the recording disk driving device 800 may be 5 mm or less.

The spindle motor 100 or 200 has all the characteristics of the spindle motor according to the above-described embodiments of the present invention and may have a recording disk D mounted thereon.

The head transfer part 810 may transfer a magnetic head 815 detecting information of the recording disk D mounted on the spindle motor 100 or 200 to a position above the surface of the recording disk D to which information is to be detected.

Here, the magnetic head 815 may be disposed on a support part 817 of the head transfer part 810.

The housing 820 may include a motor mounting plate 822 and a top cover 824 shielding an upper portion of the motor mounting plate 822 in order to form an internal space receiving the spindle motor 100 and the head transfer part 810.

As set forth above, in a spindle motor according to embodiments of the present invention, a clamp for fixing a recording disk may not occupy a space in an axial direction.

While the present invention has been shown and described in connection with the embodiments, it will be apparent to those skilled in the art that modifications and variations can be made without departing from the spirit and scope of the invention as defined by the appended claims.

What is claimed is:

1. A spindle motor comprising:
a fixed member;
a rotating member rotatably supported by the fixed member using fluid dynamic pressure; and
a clamp ring inserted into an outer surface of the rotating member in a radial direction to fix a recording disk.

2. The spindle motor of claim 1, wherein the rotating member includes:
a hub body extended in an outer radial direction;
a cylindrical wall part extended downwardly from an outer end of the hub body in an axial direction; and
a disk mounting part extended from a lower end of the cylindrical wall part in the outer radial direction.

3. The spindle motor of claim 2, wherein the recording disk is positioned on the disk mounting part, and
an outer surface of the cylindrical wall part in the radial direction is provided with a fixing groove in an inner radial direction.

4. The spindle motor of claim 3, wherein a lower edge of the clamp ring in the axial direction is provided with a fixing protrusion protruding in the inner radial direction, and
the fixing protrusion is inserted into the fixing groove.

5. The spindle motor of claim 4, wherein a lower edge of the clamp ring in the axial direction is provided with a bent fixing part bent in the inner radial direction, and
the bent fixing part is inserted into the fixing groove.

6. The spindle motor of claim 3, wherein a lower edge of the clamp ring in the axial direction is inserted into the fixing groove so as to be positioned below an upper surface of the disk mounting part in the axial direction.

7. The spindle motor of claim 4, wherein the fixing protrusion is continuously provided, or includes a plurality of fixing protrusions spaced apart from each other and repeatedly provided in a circumferential direction.

8. The spindle motor of claim. 5, wherein the bent fixing part is continuously provided, or includes a plurality of bent fixing parts spaced apart from each other and repeatedly provided in a circumferential direction.

9. The spindle motor of claim 4, wherein an upper edge of the clamp ring in the axial direction is provided with a fixing flange protruding in the outer radial direction so as to press the recording disk positioned on the disk mounting part downwardly in the axial direction and fix the recording disk.

10. The spindle motor of claim 9, wherein the fixing flange is continuously provided or includes a plurality of fixing flanges spaced apart from each other and repeatedly provided in a circumferential direction.

11. The spindle motor of claim 1, wherein the clamp ring includes:
a ring body inserted in an axial direction while enclosing an outer surface of the rotating member in the radial direction;
a protrusion part extended in an inner radial direction from a lower edge of the ring body in the axial direction to be inserted into a fixing groove in the outer surface of the rotating member in the radial direction; and
a fixing flange extended in an outer radial direction from an upper edge of the ring body in the axial direction to press the recording disk downwardly in the axial direction and fix the recording disk.

12. A clamp ring comprising:
a ring body;
a protrusion part extended in an inner radial direction from a lower edge of the ring body in an axial direction; and
a fixing flange extended in an outer radial direction from an upper edge of the ring body in the axial direction.

13. A hard disk drive comprising:
the spindle motor of claim 1;
a magnetic head writing data to a recording disk and reading data from the recording disk; and
a head transfer part transferring the magnetic head to a predetermined position on the recording disk,
wherein a thickness standard of the hard disk drive is 5 mm or less.
